(19) United States
(12) Patent Application Publication
(10) Pub. No.: US 2018/0243986 A1
(43) Pub. Date: Aug. 30, 2018

(54) 3D PRINTING APPARATUS

(71) Applicant: LG ELECTRONICS INC., Seoul (KR)

(72) Inventor: Suwon SEO, Seoul (KR)

(73) Assignee: LG ELECTRONICS INC., Seoul (KR)

(21) Appl. No.: 15/557,376

(22) PCT Filed: Apr. 21, 2015
(86) PCT No.: PCT/KR2015/003975

§ 371 Date: Sep. 11, 2017

(30) Foreign Application Priority Data
Mar. 16, 2015 (KR) 10-2015-0035917

(51) Int. Cl. B29C 64/245; B29C 64/255; B29C 64/357; B29C 64/112; B29C 64/118; B29C 64/209

(52) U.S. Cl. CPC B29C 64/245; B29C 64/255; B29C 64/357; B33Y 30/00; B29C 64/118; B29C 64/209; B29C 64/112

(57) ABSTRACT

A 3D printing apparatus is provided. The 3D printing apparatus includes a liquid tank unit in which an accommodation space is defined; a nozzle unit disposed vertically movable in the accommodation space of the liquid tank unit to spray a building source for building a 3D object; and a control unit for controlling the nozzle unit, wherein a supplemental liquid for supporting the 3D object is filed in the accommodation space of the liquid tank unit.

### TECHNICAL FIELD

The present disclosure relates to a three-dimensional (3D) printing apparatus.

### BACKGROUND ART

Three-dimensional (3D) printing apparatuses are apparatuses for building three-dimensional objects, but not two-dimensional objects such as letters or pictures, on the basis of inputted design drawings. Such a 3D printing apparatus has been started in some of industries for building an object before mass production or manufacturing a sample and is gradually expanding its application range to a domestic, educational, or medical use these days.

A 3D printing apparatus according to the related art is disclosed in Korean Patent Registration Gazette No. 10-1451794. The 3D printing apparatus is classified in various manners in addition to a manner disclosed in the Gazette according to an operation manner. In detail, there are a liquid-based stereolithography (SLA) manner, a solid-based fused deposition building (FDM) manner, an inkjet manner, a selective laser sintering (SLS) manner, a laminated object manufacturing (LOM) manner, an electron beam melting (EBM) manner, and a direct metal laser sintering (DMLS) manner.

Here, in case of the SLA manner, high precision may be realized, and a 3D object may be maintained with a stable structure 3D object during its solidification. However, a building source has a high loss rate and is expensive. In case of other manners such as the FDM manner or the inkjet manner, a 3D object may be built at relatively low costs in comparison to the SLA manner, and a building source may have a low loss rate. However, in case of the FDM manner or the inkjet manner, when building the 3D object, a separate support for supporting the 3D object has to be provided, and thus a process for removing the support has to be performed after the solidification. Thus, in these manners, a time for building the support may be required in addition to a time for building the 3D object, and the building source for manufacturing the support that has to be removed later may be wasted.

Therefore, it is necessary to find a solution for stably supporting the 3D object during the building while reducing losses of the building source, time, and costs in the 3D printing apparatus.

### DISCLOSURE OF INVENTION

### Technical Problem

Embodiments provide a 3D printing apparatus that is capable of stably supporting a 3D object during building while reducing losses of a building source, time, and cost.

### Solution to Problem

In one embodiment, a 3D printing apparatus includes: a liquid tank unit in which an accommodation space is defined; a nozzle unit disposed vertically movable in the accommodation space of the liquid tank unit to spray a building source for building a 3D object; and a control unit for controlling the nozzle unit, wherein a supplemental liquid for supporting the 3D object is filed in the accommodation space of the liquid tank unit.

The liquid tank unit may include: a first liquid tank defining an outer appearance of the liquid tank unit; and a second liquid tank defining the accommodation space, the second liquid tank being disposed in the first liquid tank to communicate with the first liquid tank.

The nozzle unit may include: a nozzle head for spraying the building source; a nozzle base on which the 3D object is layered according to the spray of the building source; a driving part for vertically moving the nozzle base; and a driving shaft through which the driving part is connected to at least one of the nozzle head and the nozzle base, the driving shaft vertically moving according to an operation of the driving part.

The supplemental liquid may be filled into the accommodation space to a height less than that of an upper end of the nozzle base when the nozzle unit is not driven.

The nozzle unit may operate in at least one of a first layering mode in which the 3D object is layered from an upper side of the accommodation space and a second layering mode in which the 3D object is layered from a lower side of the accommodation space.

In the first layering mode, the driving shaft may connect the nozzle base to the driving part.

In the first layering mode, the nozzle base may move to the lower side of the accommodation space and is disposed in the supplemental liquid, and a portion of the 3D object may be disposed in the supplemental liquid so that the 3D object is supported by the supplemental liquid.

A portion of the supplemental liquid may flow into the first liquid tank according to descent of the nozzle base in a state where the supplemental liquid is filled up to a position that is adjacent to an upper end of the accommodation space.

An amount of supplemental liquid flowing into the first liquid tank may be determined by volumes of the nozzle base and the 3D object to be layered.

A supplemental liquid tank for accommodating the supplemental liquid flowing from the second liquid tank may be disposed in the first liquid tank.

The supplemental liquid tank may surround the second liquid tank and has an upper end that is higher than an upper end of the second liquid tank.

In the second layering mode, the driving shaft may connect the nozzle head to the driving part.

In the second layering mode, the nozzle head may move to the upper side of the accommodation space while spraying the building source, and a portion of the 3D object may be disposed in the supplemental liquid so that the 3D object is supported by the supplemental liquid.

The supplemental liquid may be accommodated in the first liquid tank, and the supplemental liquid accommodated in the first liquid tank may flow into the second liquid tank when the 3D object is layered.

A pump unit connected to the control unit to allow the supplemental liquid to flow into the second liquid tank may be disposed in the first liquid tank.

A liquid level adjustment sensor connected to the control unit to adjust a level of the supplemental liquid may be disposed in the second liquid tank.

A filter unit for filtering impurities from the second liquid tank may be disposed in the first liquid tank.

A connection passage through which the first liquid tank is connected to the second liquid tank may be disposed in the first liquid tank, and the filter unit may be disposed in the connection passage.

The supplemental liquid may have a polarity different from that of the building source.

The supplemental liquid may be formed of an incombustible material.

The details of one or more embodiments are set forth in the accompanying drawings and the description below. Other features will be apparent from the description and drawings, and from the claims.

### Advantageous Effects of Invention

According to the above-described various embodiments, a 3D printing apparatus that is capable of stably supporting a 3D object during building while reducing losses of a building source, time, and cost may be provided.

### BRIEF DESCRIPTION OF DRAWINGS

FIG. 1 is a view illustrating a three-dimensional (3D) printing apparatus according to an embodiment.

FIGS. 2 to 6 are views illustrating operations of the 3D printing apparatus of FIG. 1 in a first layering mode.

FIGS. 7 to 11 are views illustrating operations of the 3D printing apparatus of FIG. in a second layering mode.

FIG. 12 is a view of a mobile device controlling the 3D printing apparatus of FIG. 1.

FIGS. 13 to 24 are views for explaining various embodiments by the mobile device of FIG. 12.

### MODE FOR THE INVENTION

Reference will now be made in detail to the embodiments of the present disclosure, examples of which are illustrated in the accompanying drawings. It should be construed that embodiments herein are exemplified to provide more general understandings of the embodiments of the present invention, and various changes and modifications may be made thereto by one skilled in the art without departing from the scope and spirit of the invention as set forth in the appended claims. In the drawings, the thicknesses of layers and regions are exaggerated for clarity.

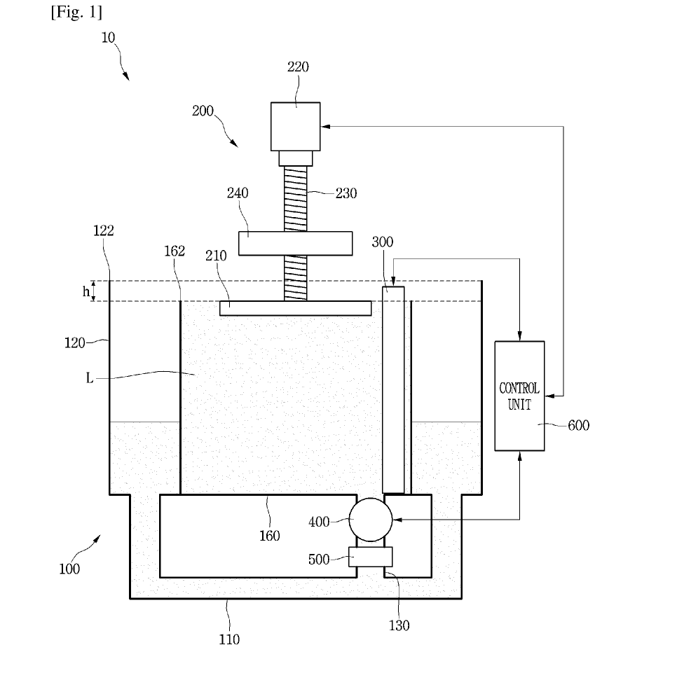

FIG. 1 is a view illustrating a three-dimensional (3D) printing apparatus according to an embodiment.

Referring to FIG. 1, a 3D printing apparatus 10 includes a liquid tank unit 100, a nozzle unit 200, a liquid level adjustment sensor 300, a pump unit 400, a filter unit 500, and a control unit 600.

The liquid tank unit 100 has a shape in which an accommodation space is defined. The liquid tank unit 100 includes a first liquid tank 110 and a second liquid tank 160.

The first liquid tank 110 defines an outer appearance of the liquid tank unit 100. The first liquid tank 110 includes a supplemental liquid tank 120 and a connection passage 130.

The supplemental liquid tank 120 surrounds a second liquid tank 160 that will be described later. The supplemental liquid tank 120 has an inner space for accommodating a supplemental liquid L flowing from the second liquid tank 160 or supplementally accommodating the supplemental liquid L.

The supplemental liquid tank 120 has an upper end 122 that is disposed by a predetermined height h higher than an upper end 162 of the second liquid tank 160. That is, the first liquid tank 110 has the upper end 122 that is disposed higher than the upper end of the second liquid tank 160. Thus, overflow of the supplemental liquid L overflowing from the second liquid tank 160 out of the first liquid tank 110 may be prevented.

The first liquid tank 110 is connected to the second liquid tank 160 through the connection passage 130. Thus, the supplemental liquid L may circulate in the first and second liquid tanks 120 and 160. Pump and filter units 400 and 500 that will be described later are disposed on the connection passage 130.

The second liquid tank 160 is disposed in the first liquid tank 110 to define an accommodation space for accommodating the supplemental liquid L. The second liquid tank 160 communicates with the first liquid tank 110 through the connection passage 130.

Here, the supplemental liquid L accommodated in the accommodation space of the second liquid tank 160 is a liquid for supporting a 3D object layered when the 3D object is built. When the 3D object is built, the supplemental liquid L may prevent the layered 3D object from collapsing by gravity and cool the 3D object at a high temperature and smooth a surface of the 3D object.

The supplemental liquid L may be provided with a liquid having a polarity different from that of a building source so that the supplemental liquid L is not mixed with the building source. That is, when the building source has a polarity, the supplemental liquid L may have non-polarity, and when the building source has non-polarity, the supplemental liquid L may have a polarity.

Also, the supplemental liquid L may be provided with an incombustible material.

This is done because to prevent friction of the building source and fire that may be generated by heat of a nozzle head 240 that will be described later from occurring when the 3D object is built.

Like this, in the current embodiment, when the 3D object is built, since the 3D object is supported by the supplemental liquid L, the layered 3D object may be stably supported without an additional support for supporting the 3D object.

Thus, in the current embodiment, when the 3D object is built, the 3D printing apparatus may prevent a time for building the support and the building source for manufacturing the support that has to be removed later from being wasted.

As a result, the 3D printing apparatus 10 according to the current embodiment may be significantly improved in manufacturing efficiency and manufacturing costs of the 3D object.

Referring again to the structure of the 3D printing apparatus 10, a nozzle unit 200 is provided for building the 3D object. The nozzle unit may spray a building source for building to layer and realize the 3D object. The nozzle unit 200 may vertically move in the liquid tank unit 100, particularly, in the accommodation space of the second liquid tank 160.

The nozzle unit 200 includes a nozzle base 210, a driving part 220, a driving shaft 230, and the nozzle head 240.

The 3D object is layered on the nozzle base 210 according to the spray of the building source from the nozzle head 240 when the 3D object is built. The 3D object layered on the nozzle base 210 is realized as a target 3D object while being layered upward the nozzle base 210. When the nozzle unit 200 is not driven, the supplemental liquid L may be filled into the accommodation space to a height lower than that of an upper end of the nozzle base 210. If the supplemental liquid L is filled to the position higher than that of the upper end of the nozzle base 210, the supplemental liquid L may disrupt the building of the 3D object when the nozzle unit 200 is driven.

The driving part 220 is connected to a control unit 600 that will be described later to control movement of the nozzle base 210 and the nozzle head 240. For example, the driving part 220 may control vertical movement of the nozzle base 210 and the nozzle head 240.

At least one of the nozzle base 210 and the nozzle head 240 is connected to the driving part 220 through the driving shaft 230. The driving shaft 230 may vertically move according to an operation of the driving part 220. Thus, at least one of the nozzle base 210 and the nozzle head may vertically move.

The nozzle head 240 may spray the building source for building the 3D object toward the nozzle base 210. The nozzle head 240 may be fixedly mounted on a separate constitution or be movably mounted on the driving shaft 230 in a vertical direction.

The nozzle unit 200 having the above-described constitutions may operate at least one layering mode of a first layering mode and a second layering mode when the 3D object according to the spray of the building source by the nozzle head 240 is built.

The first layering mode is a layering mode in which a 3D object is layered from an upper side of the accommodation space of the second liquid tank 160. The second layer mode is a layering mode in which a 3D object is layered from a lower side of the accommodation space of the second liquid tank 160.

In the first layering mode, the driving shaft 230 of the nozzle unit 200 may connect the nozzle base 210 to the driving part 220. Thus, the nozzle base 210 may vertically move in the accommodation space of the second liquid tank 160.

In the first layer mode, the nozzle base 210 moves to the lower side of the accommodation space of the second liquid tank 160 and is disposed in the supplemental liquid L. Also, a portion of the 3D object layered on the nozzle base 210 is disposed in the supplemental liquid L and thus is supported by the supplemental liquid L.

Also, in the first layering mode, a portion of the supplemental liquid L may flow into the first liquid tank 110, particularly into the supplemental liquid tank 120 according to descent of the nozzle base 210 in a state where the supplemental liquid L is filled up to a position adjacent to the upper end of the second liquid tank 160. That is, the supplemental liquid L may overflow to the supplemental liquid tank 120. Here, an amount of the supplemental liquid L flowing into the supplemental liquid tank 120 may be determined according to volumes of the nozzle base 210 and the layered 3D object.

In the second layering mode, the driving shaft 230 of the nozzle unit 200 may connect the driving part 220 to the nozzle head 240. Thus, the nozzle head 240 may vertically move in the accommodation space of the second liquid tank 160 while spraying the building source for building the 3D object. Also, a portion of the 3D object layered on the nozzle base 210 is disposed in the supplemental liquid L so that the 3D object is supported by the supplemental liquid L.

In the second layering mode, the supplemental liquid L is accommodated into the first liquid tank 110. Here, the supplemental liquid L accommodated into the first liquid tank 110 flows into the second liquid tank 160 when the 3D object is layered. Here, a pump unit 400 that will be described later may provide a flow force for allowing the supplemental liquid L of the first liquid tank 110 to flow into the second liquid tank 160.

The liquid level adjustment sensor 300 is provided to adjust a level of the supplemental liquid L in the second liquid tank 160. The liquid level adjustment sensor 160 is disposed in the second liquid tank 160 and connected to the control unit 600. The liquid level adjustment sensor 300 may detect an initial liquid level of the second liquid tank 160 in the first layering mode. Also, in the second layering mode, the liquid level adjustment sensor 300 may detect the liquid level of the second liquid tank 160 from a beginning to an end of the building of the 3D object.

The pump unit 400 may provide a flow force for allowing the supplemental liquid L to flow. The pump unit 400 is disposed in the connection passage 130 of the first liquid tank 110 and connected to the control unit 600.

The filter unit 500 is provided to filter impurities from the second liquid tank 160. The filter unit 500 is disposed in the connection passage 130 of the first liquid tank 110. Thus, impurities such as the building source for building the 3D object or remaining 3D object from the second liquid tank 160 may be filtered by the filter unit 500 and thus not flow into the first liquid tank 110.

The control unit 600 may control overall operations of the nozzle unit 200, the liquid level adjustment sensor 300, the pump unit 400, and various components of the 3D printing apparatus. The control unit 600 may control driving of the nozzle unit 200 and operations of the liquid level adjustment sensor 300 and the pump unit 400.

Hereinafter, detailed operations of the 3D printing apparatus according to an embodiment will be described in detail.

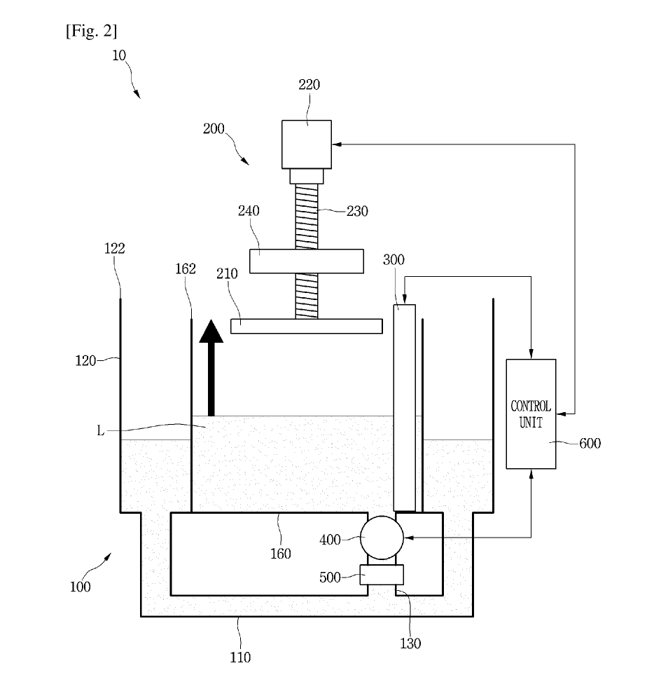

FIGS. 2 to 6 are views illustrating operations of the 3D printing apparatus of FIG. 1 in a first layering mode.

Referring to FIG. 2, when the 3D object is built according to the first layering mode, the 3D printing apparatus 10 substantially fills the supplemental liquid L in the accommodation space of the second liquid tank 160. Here, the supplemental liquid L may be filled from the upper side of the second liquid tank or introduced from the first liquid tank 110 into the second liquid tank 160 through the driving of the pump unit 400.

Here, the nozzle base 210 of the nozzle unit 200 is disposed adjacent to the upper end of the second liquid tank 160. Here, the supplemental liquid L may be filled into the accommodation space of the second liquid tank 160 so that the nozzle base 210 does not overflow with the supplemental liquid L. The level of the supplemental liquid L may be appropriately adjusted through liquid level detection of the liquid level adjustment sensor 300.

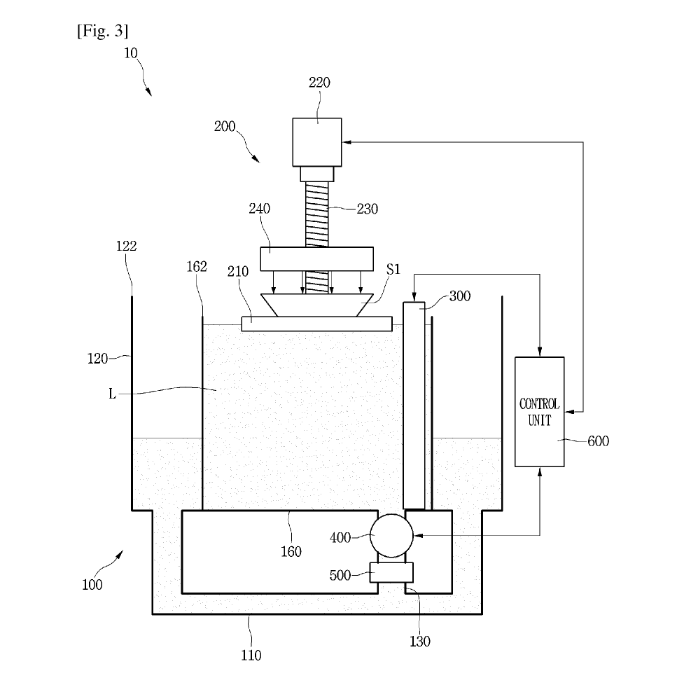

Referring to FIG. 3, the nozzle head 240 of the nozzle unit 200 may spray the building source for building the 3D object to complete a first layer object S1 on the nozzle base 210.

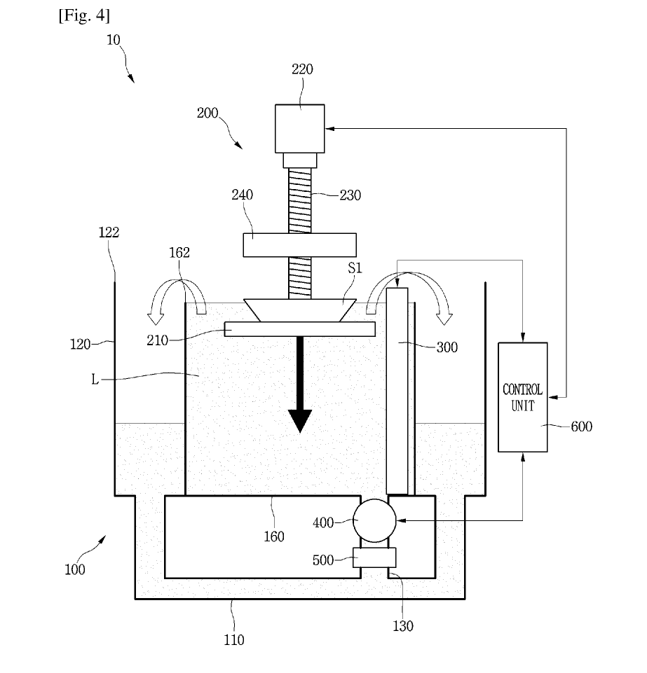

Referring to FIG. 4, when the first layer object S1 is completed, the driving part 220 of the nozzle unit 200 may allow the driving shaft 230 to descend so that the nozzle base 210 moves downward. The driving shaft 230 may descend until the first layer object S1 is dipped into the supplemental liquid L. Here, the driving shaft may descend until the uppermost end of the first layer object S1 is not dipped into the supplemental liquid L. A portion of the supplemental liquid L may naturally overflow according to the descent of the nozzle base 210 and the first layer object S1 and thus be filled into the supplemental liquid tank 120 of the first liquid tank 110.

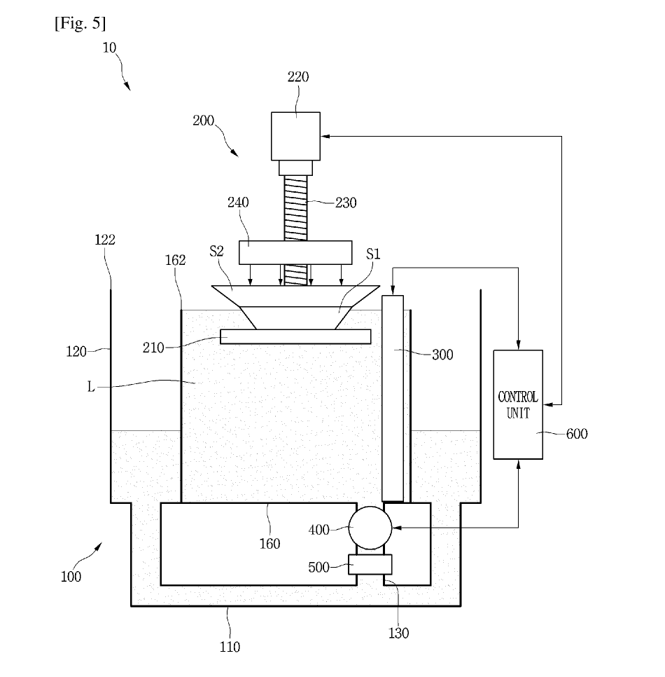

Referring to FIG. 5, the nozzle head 240 of the nozzle unit 200 may spray the building source on the first layer object S1 to complete a second layer object S2 on the first layer object S1.

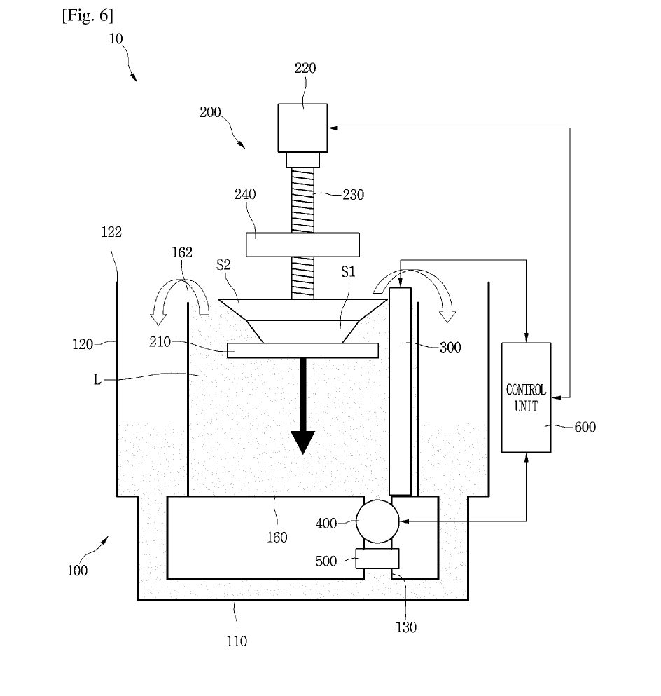

Referring to FIG. 6, when the second layer object S1 is completed, the driving part 220 of the nozzle unit 200 may allow the driving shaft 230 to descend so that the nozzle base 210 moves downward again. The driving shaft 230 may descend until the second layer object S2 is dipped into the supplemental liquid L. Here, the driving shaft 230 may descend until the uppermost end of the second layer object S2 is not dipped into the supplemental liquid L. A portion of the supplemental liquid L may naturally overflow according to the descent of the first layer object S1 and the second layer object S2 and thus be filled into the supplemental liquid tank 120 of the first liquid tank 110.

In the first layering mode, the above-described process is repeatedly performed. When the object is completely layered to a final layer, the first layering mode is finished. Then, the completed 3D object is taken out of the second liquid tank 160.

Like this, the 3D printing apparatus 10 according to the current embodiment may build the 3D object while stably supporting the object to be layered by the supplemental liquid L when the 3D object is built. The above-described manner according to the current embodiment may be used in the manner for building the 3D object while layering the objects such as an inkjet manner or a FDM manner.

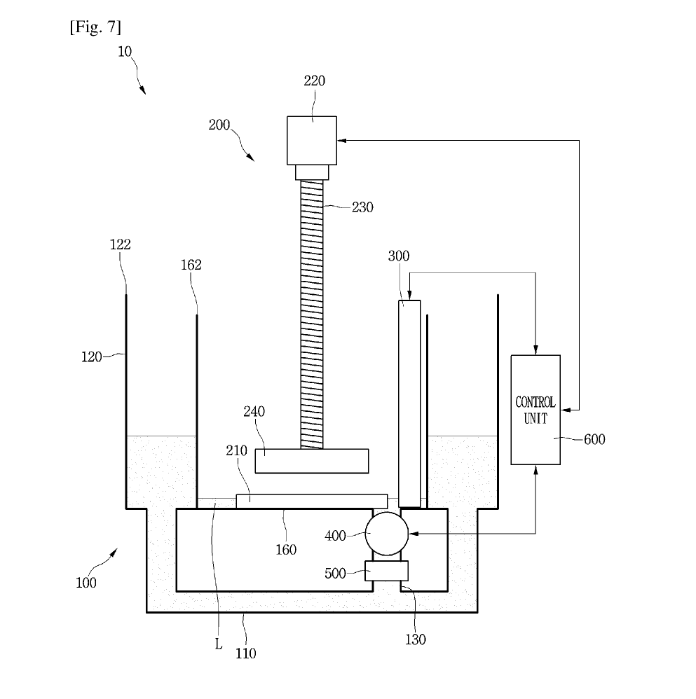

FIGS. 7 to 11 are views illustrating operations of the 3D printing apparatus of Fig. in a second layering mode.

Referring to FIG. 7, when the 3D object is built according to the second layering mode, the 3D printing apparatus 10 allows the nozzle base 210 of the nozzle unit 200 to be disposed at a lower end side of the second liquid tank 160. Also, the 3D printing apparatus 10 may fill the supplemental liquid L into the accommodation space of the second liquid tank 160. Here, the 3D printing apparatus 10 may fill the supplemental liquid L into the accommodation space to a height less than the upper end of the nozzle base 210.

The supplemental liquid L may flow from the first liquid tank 110 into the second liquid tank 160 through the pump unit 400. Also, the level of the supplemental liquid L may be detected by the liquid level adjustment sensor 300.

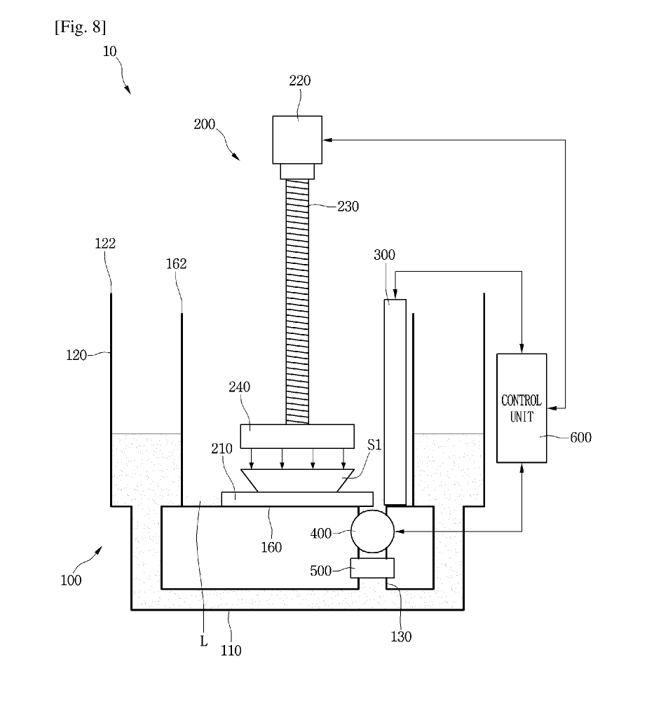

In the current embodiment, the nozzle base 210 may be omitted. When the nozzle base 210 is omitted, the supplemental liquid L may be filled into the accommodation space of the second liquid tank 160 to a height lower than that of a first layer object S1 after the first layer object (see reference symbol S1 of FIG. 8) that will be described later is completed.

Referring to FIG. 8, the nozzle head 240 of the nozzle unit 200 may spray the building source for building the 3D object to complete a first layer object S1 on the nozzle base 210.

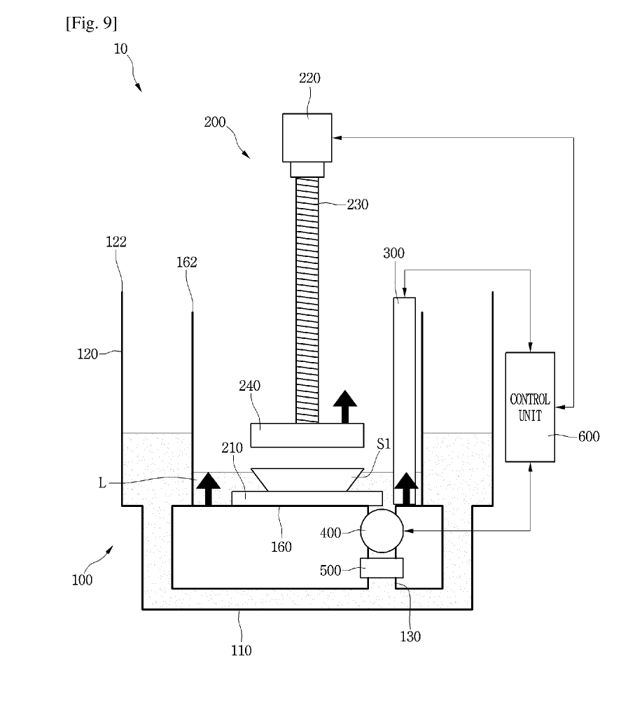

Referring to FIG. 9, when the first layer object S1 is completed, the driving part 220 of the nozzle unit 200 may allow the driving shaft 230 to ascend so that the nozzle head 240 moves upward.

Also, the 3D printing apparatus 10 may allow the supplemental liquid L to flow from the first liquid tank 110 into the second liquid tank 160 so that the first layer object S1 is dipped into the supplemental liquid L. Here, the supplemental liquid L may flow into the second liquid tank 160 to a position in which the uppermost end of the first layer object S1 is not dipped into the supplemental liquid L. Similarly, the supplemental liquid L may flow through the pump unit 400, and the level of the supplemental liquid L may be detected by the liquid level adjustment sensor 300.

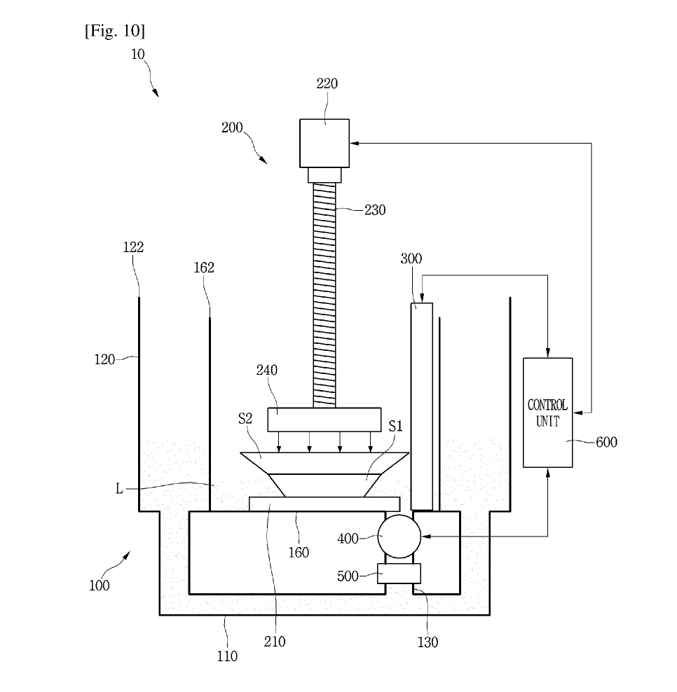

Referring to FIG. 10, the nozzle head 240 of the nozzle unit 200 may spray the building source on the first layer object S1 to complete a second layer building S2 on the first layer object S1.

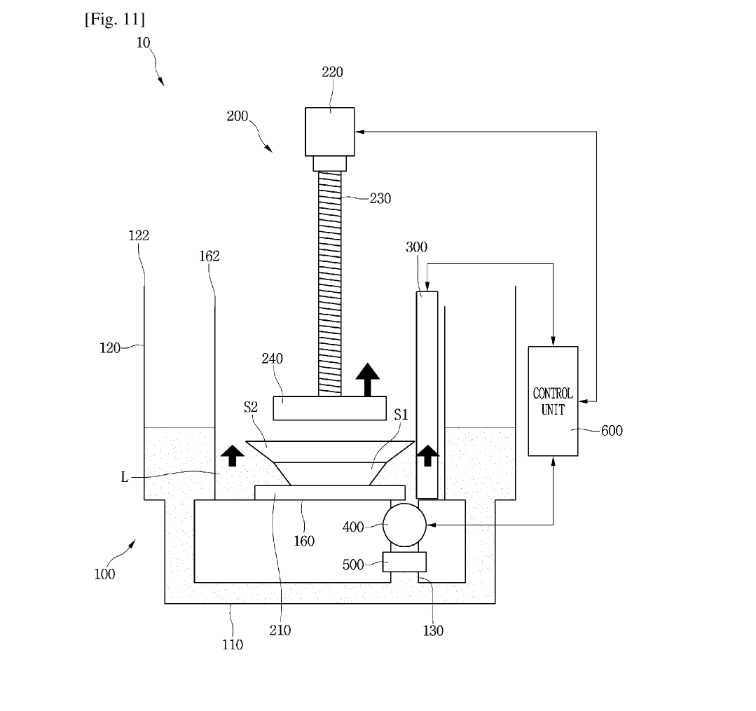

Referring to FIG. 11, when the second layer object S2 is completed, the driving part of the nozzle unit 200 may allow the driving shaft 230 to ascend so that the nozzle head 240 moves upward again.

Also, the 3D printing apparatus 10 may allow the supplemental liquid L to flow again from the first liquid tank 110 into the second liquid tank 160 so that the second layer object S1 is dipped into the supplemental liquid L. Here, the supplemental liquid L may flow into the second liquid tank 160 to a position in which the uppermost end of the second layer object S2 is not dipped into the supplemental liquid L. Similarly, the supplemental liquid L may flow through the pump unit 400, and the level of the supplemental liquid L may be detected by the liquid level adjustment sensor 300.

In the second layering mode, the above-described process is repeatedly performed. When the object is completely layered to a final layer, the second layering mode is finished. Then, the completed 3D object is taken out of the second liquid tank 160.

Like this, the 3D printing apparatus according to the current embodiment may stably realize the building of the 3D object according to various layering modes without a separate support.

Hereinafter, various embodiments for a mobile device connected to the 3D printing apparatus according to an embodiment are described.

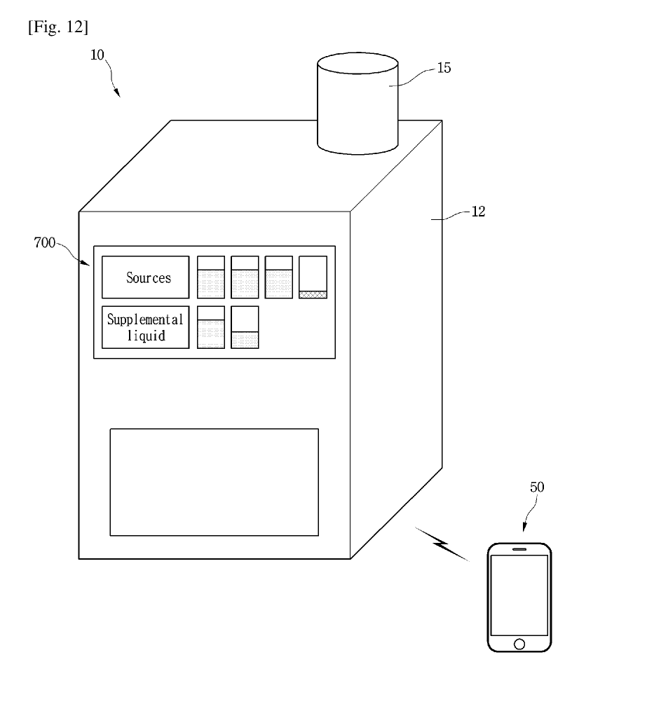

FIG. 12 is a view of a mobile device controlling the 3D printing apparatus of FIG. 1.

Referring to FIG. 12, the 3D printing apparatus 10 includes a casing 12, an inflow hole 15, and a display part 700.

The casing 12 defined an outer appearance of the 3D printing apparatus 10. The above-described various components constituting the 3D printing apparatus 10 may be built in the casing 12. Shape of the casing 12 may properly vary according to design.

The inflow hole 15 is a component for supplying the above-described supplemental liquid L and the building source from the outside into the 3D printing apparatus 10. The supplemental liquid L and the building source may be supplied into the 3D printing apparatus 10 through the inflow hole 15. The inflow hole 15 may be connected to each of the liquid tank unit (see reference numeral 100 of FIG. 1) and the nozzle unit (see reference numeral 200 of FIG. 1).

The display part 700 may visually provide various information of the 3D printing apparatus 10 to a user. The display part 700 may visually display various information of the 3D printing apparatus such as an amount or kind of the supplemental liquid L and an amount of kind of the building source to allow the user to recognize the various information.

Also, the 3D printing apparatus 10 constituted by the components may be wirelessly connected to a mobile device 50. The mobile device 50 may have various applications that is capable of controlling operations of the 3D printing apparatus 10 to control the various operation so of the 3D printing apparatus 10 by manipulating the applications. Thus, the user may control the operations of the 3D printing apparatus 10 by manipulating the mobile device 50.

Hereinafter, various embodiments in which various operations of the 3D printing apparatus 10 are controlled by manipulating the mobile device 50 will be described.

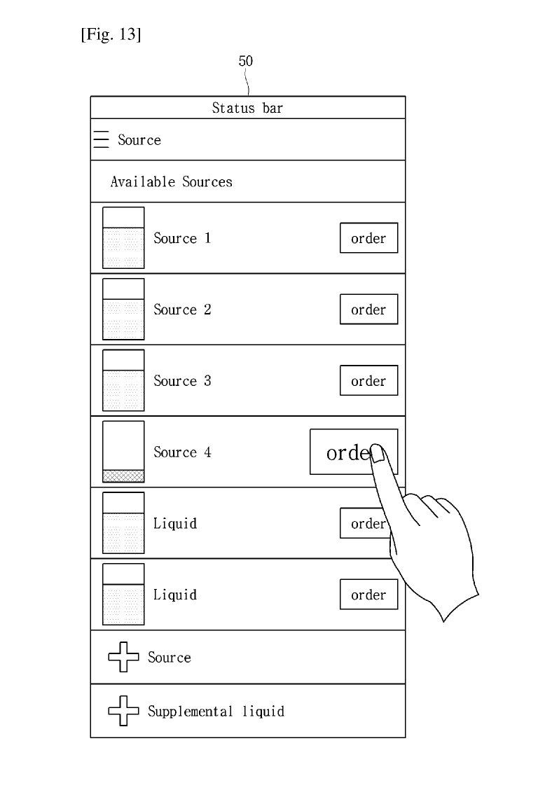

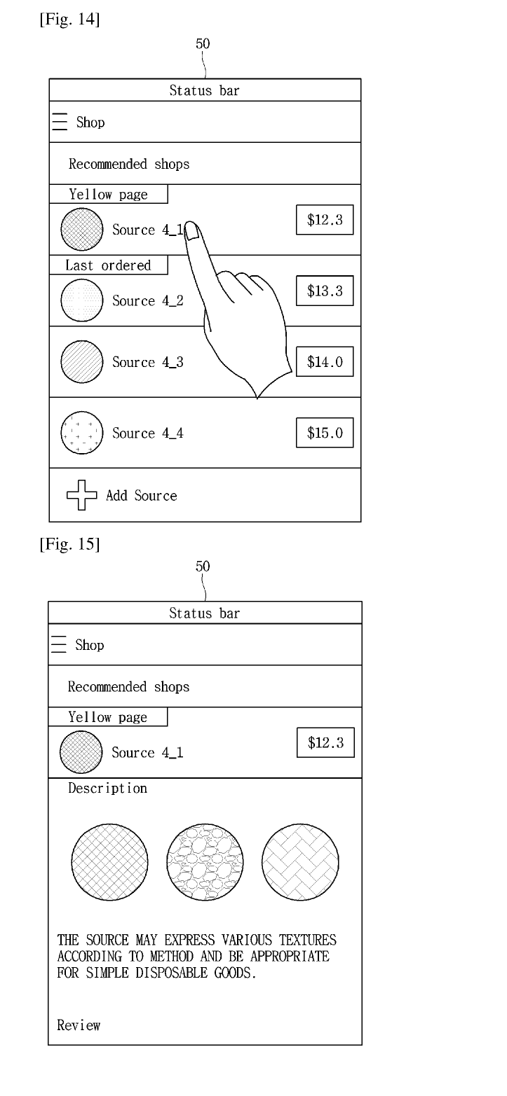

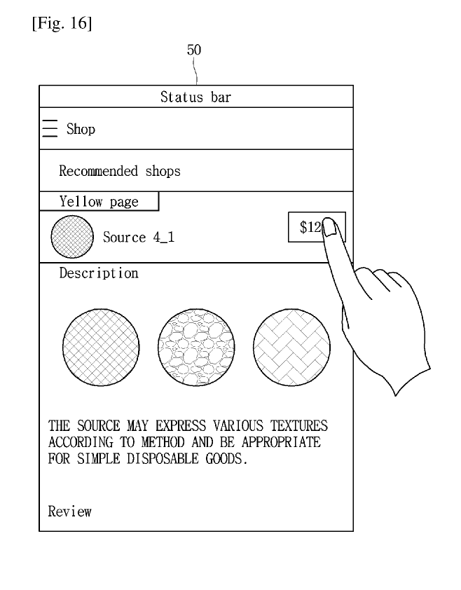

FIGS. 13 to 24 are views for explaining various embodiments by the mobile device of FIG. 12.

Referring to FIGS. 13 to 16, the user may select and order the building source as desired by using the mobile device 50. The building source may be variously provided. The user may order and pay for the building source as necessary according to the intended use.

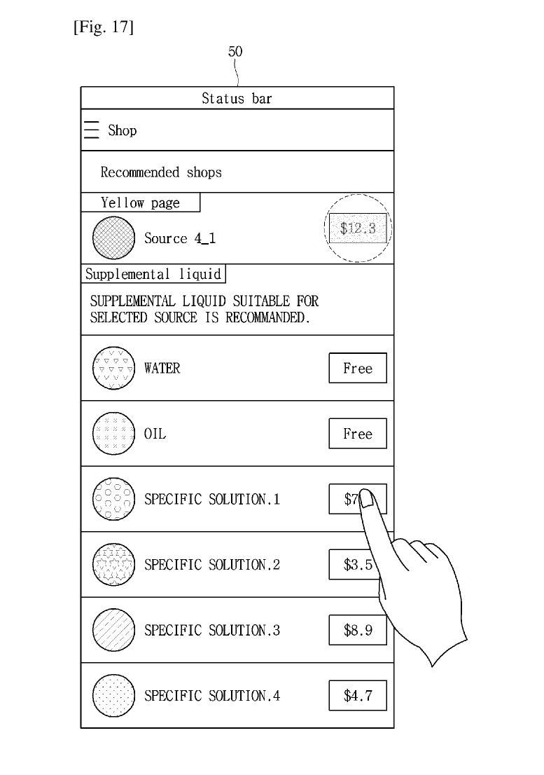

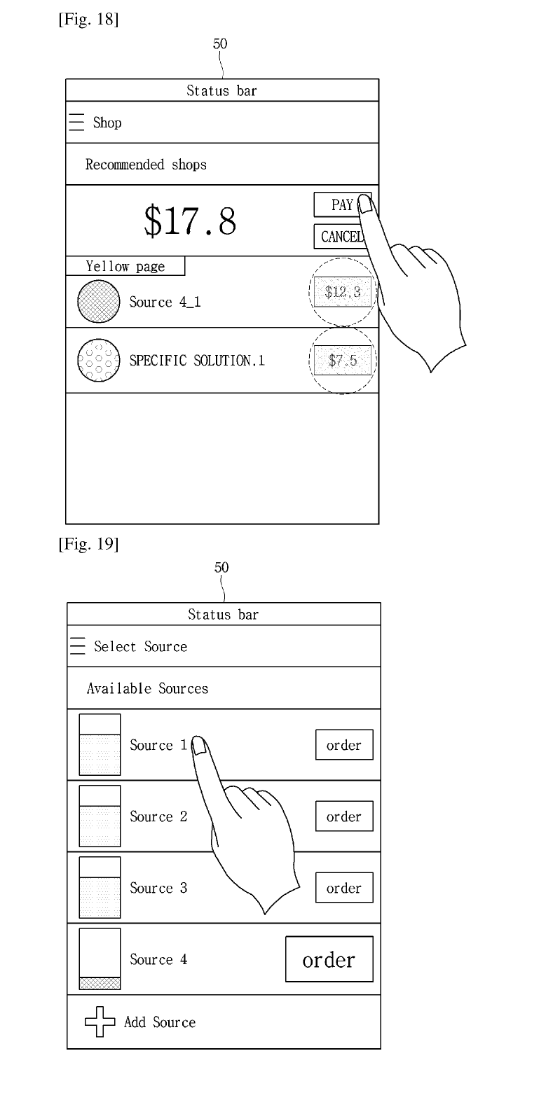

Referring to FIGS. 17 and 18, the user may select and order the supplemental liquid that is appropriate for the building source by using the mobile device 50. The application of the mobile device 50 may provide information of various supplemental liquids appropriate for the selected building source to the user. The user may select a desired supplemental liquid of the supplemental liquids to simply order and pay for the selected supplemental liquid.

Referring to FIG. 19, when the user selects the building source, the application of the mobile device 50 may allow an optimal supplemental liquid corresponding to the building source selected by the user to be automatically selected. In this case, the user may automatically select the supplemental liquid corresponding to his selection by only selecting the building source.

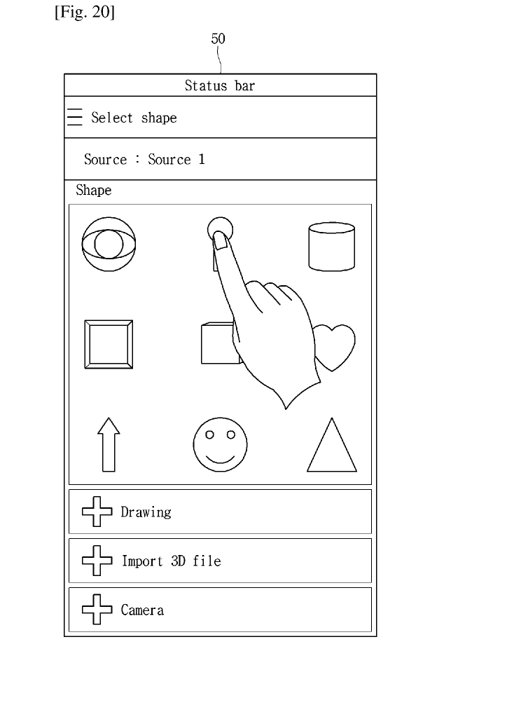

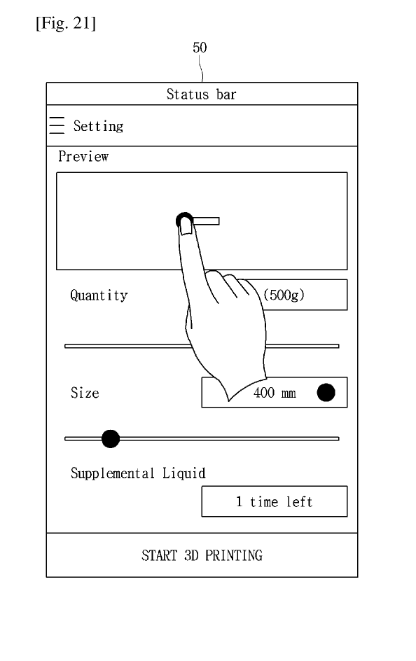

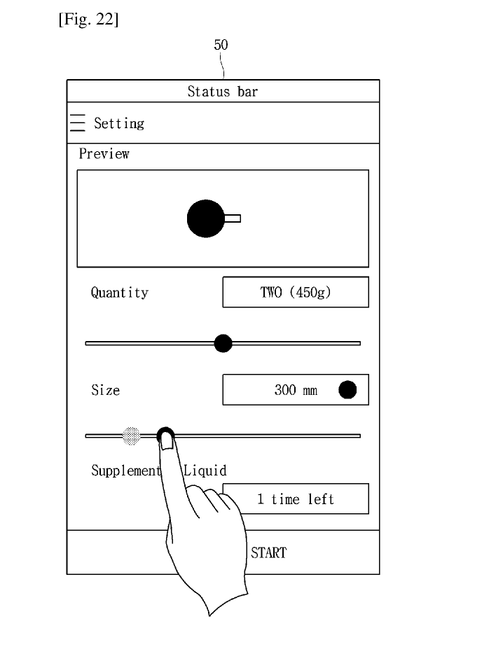

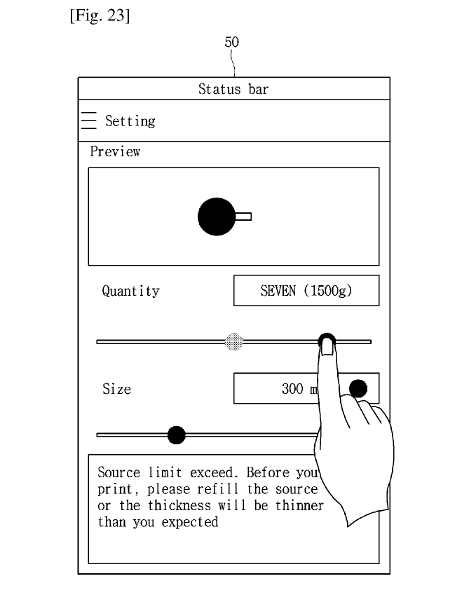

Referring to FIG. 20, the user may select the shape of the desired 3D object in the mobile device 50. Referring to FIG. 21, the user may touch the mobile device 50 to adjust the selected shape of the 3D object on a sample screen in a box. Also, when the user touches a portion except for the box, the originally selected area may be released. Referring to FIG. 22, the mobile device 50 may provide the number of the 3D object to be made according to the selected size by the user. Referring to FIG. 23, when the user selects the number of the 3D object which may not be made with the present amount of the building source, the mobile device 50 may provide a warning pop-up to the user.

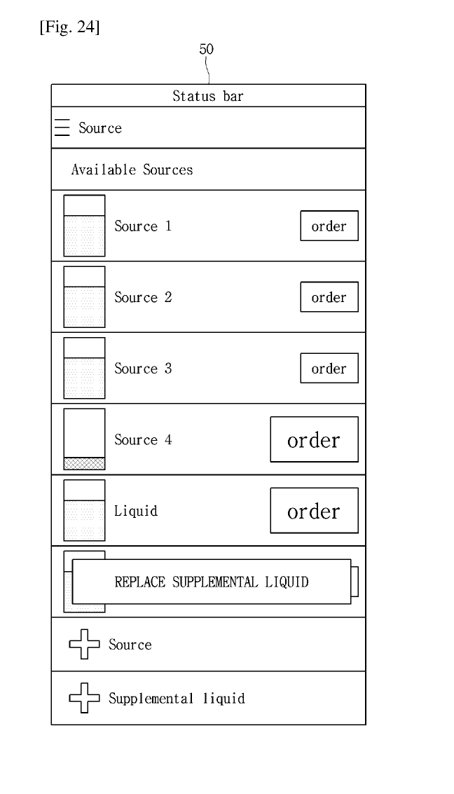

Referring to FIG. 24, when the supplemental liquid is insufficient, the mobile device 50 may provide the lack of the supplemental liquid to the user by notification. That is, when the supplemental liquid is insufficient, the mobile device 50 may turn on a warning light or provide an alarm sound.

Like this, the 3D printing apparatus according to the current embodiment may be wirelessly connected to the mobile device 50. Thus, the operations of the 3D printing apparatus may be various controlled by manipulating the mobile device 50. Since the above-described embodiments are exemplary provided, various interfaces performed in the 3D printing apparatus may be provided as an application of the mobile device 50 in addition to the foregoing embodiments.

Although embodiments have been described with reference to a number of illustrative embodiments thereof, it should be understood that numerous other modifications and embodiments can be devised by those skilled in the art that will fall within the spirit and scope of the principles of this disclosure.

1. A 3D printing apparatus comprising:
a liquid tank unit having an accommodation space defined therein;
a nozzle unit vertically movable in the accommodation space of the liquid tank unit, the nozzle unit being configured to spray a building source for building a 3D object;
a control unit configured to control the nozzle unit; and
a supplemental liquid provided in the accommodation space of the liquid tank for supporting the 3D object.

2. The 3D printing apparatus according to claim 1, wherein the liquid tank unit comprises:
a first liquid tank defining an outer appearance of the liquid tank unit; and
a second liquid tank defining the accommodation space, the second liquid tank disposed inside the first liquid tank and configured to communicate with the first liquid tank.

3. The 3D printing apparatus according to claim 2, wherein the nozzle unit comprises:
a nozzle head for spraying the building source;
a nozzle base on which the 3D object is layered according to the spray of the building source;
a driving part for vertically moving the nozzle base; and
a driving shaft through which the driving part is connected to at least one of the nozzle head and the nozzle base, the driving shaft configured to vertically move according to an operation of the driving part.

4. The 3D printing apparatus according to claim 3, wherein the supplemental liquid is provided in the accommodation space at a height less than that of an upper end of the nozzle base when the nozzle unit is not driven.

5. The 3D printing apparatus according to claim 4, wherein the nozzle unit operates in at least one of a first layering mode in which the 3D object is layered from an upper side of the accommodation space and a second layering mode in which the 3D object is layered from a lower side of the accommodation space.

6. The 3D printing apparatus according to claim 5, wherein, in the first layering mode, the driving shaft connects the nozzle base to the driving part.

7. The 3D printing apparatus according to claim 6, wherein, in the first layering mode, the nozzle base moves to the lower side of the accommodation space and is disposed in the supplemental liquid, and
wherein a portion of the 3D object is disposed in the supplemental liquid so that the 3D object is supported by the supplemental liquid.

8. The 3D printing apparatus according to claim 7, wherein a portion of the supplemental liquid overflows into the first liquid tank according to descent of the nozzle base in a state where the supplemental liquid is filled up to a position that is adjacent to an upper end of the accommodation space.

9. The 3D printing apparatus according to claim 8, wherein an amount of supplemental liquid overflowing into the first liquid tank is determined by volumes of the nozzle base and the 3D object to be layered.

10. The 3D printing apparatus according to claim 8, further comprising a supplemental liquid tank disposed in the first liquid tank for accommodating the supplemental liquid overflowing from the second liquid tank .

11. The 3D printing apparatus according to claim 10, wherein the supplemental liquid tank surrounds the second liquid tank and has an upper end that is higher than an upper end of the second liquid tank.

12. The 3D printing apparatus according to claim 5, wherein, in the second layering mode, the driving shaft connects the nozzle head to the driving part.

13. The 3D printing apparatus according to claim 12, wherein, in the second layering mode, the nozzle head moves to the upper side of the accommodation space while spraying the building source, and
wherein a portion of the 3D object is disposed in the supplemental liquid so that the 3D object is supported by the supplemental liquid.

14. The 3D printing apparatus according to claim 13, wherein the supplemental liquid is accommodated in the first liquid tank, and
wherein the supplemental liquid accommodated in the first liquid tank overflows into the second liquid tank when the 3D object is layered.

15. The 3D printing apparatus according to claim 2, further comprising a pump unit disposed in the first liquid tank and connected to the control unit to allow the supplemental liquid to flow into the second liquid tank.

16. The 3D printing apparatus according to claim 2, further comprising a liquid level adjustment sensor disposed in the second liquid tank and connected to the control unit to adjust a level of the supplemental liquid.

17. The 3D printing apparatus according to claim 2, further comprising a filter unit disposed in the first liquid tank for filtering impurities from the second liquid tank.

18. The 3D printing apparatus according to claim 17, further comprising a connection passage through which the first liquid tank is connected to the second liquid tank,
wherein the filter unit is disposed in the connection passage.

19. The 3D printing apparatus according to claim 1, wherein the supplemental liquid has a polarity different from that of the building source.

20. The 3D printing apparatus according to claim 1, wherein the supplemental liquid is an incombustible material.
